(19) United States
(12) Patent Application Publication
(10) Pub. No.: US 2025/0324144 A1
(43) Pub. Date: Oct. 16, 2025

(54) METHOD OF GENERATING VIDEO, METHOD OF PROCESSING VIDEO, DEVICE AND STORAGE MEDIUM

(71) Applicant: BEIJING BAIDU NETCOM SCIENCE TECHNOLOGY CO., LTD., Beijing (CN)

(72) Inventors: Xuesong WANG, Beijing (CN); Xiaowen CHENG, Beijing (CN); Kangcheng YANG, Beijing (CN); Rui YANG, Beijing (CN)

(21) Appl. No.: 19/242,617

(22) Filed: Jun. 18, 2025

(30) Foreign Application Priority Data
Sep. 18, 2024 (CN) 202411304052.8

(51) Int. Cl. H04N 21/81

(52) U.S. Cl. CPC H04N 21/816

(57) ABSTRACT

A method of generating a video, a method of processing a video, an electronic device and a storage medium, which relate to a field of artificial intelligence technology, and in particular to fields of large model technology, video processing technology, virtual digital character technology, etc. The method of generating a video includes: determining a plurality of initial prompt texts according to an initial text input by a user, where the plurality of initial prompt texts include an initial content prompt text and an initial material prompt text; determining a video content text and at least one initial object action driving data corresponding to the video content text according to the initial content prompt text; and generating an initial video according to the at least one initial object action driving data and at least one initial material corresponding to at least one initial material prompt text.

This application claims the benefit of priority to Chinese Patent Application No. 202411304052.8, filed on Sep. 18, 2024. The entire contents of this application are hereby incorporated herein by reference.

### TECHNICAL FIELD

The present disclosure relates to a field of artificial intelligence technology, and in particular to fields of large model technology, video processing technology, virtual digital character technology, etc., which may be applied to various video production scenarios such as a social media video, a marketing video, an education and training video, a news reporting video, an entertainment and leisure video, an e-commerce video, a stylized animation video, etc. More specifically, the present disclosure provides a method of generating a video, a method of processing a video, an electronic device and a storage medium.

### BACKGROUND

With a development of an artificial intelligence technology, application scenarios of a large model are constantly expanding. Based on the artificial intelligence technology, a video may be generated based on a text input by a user.

### SUMMARY

The present disclosure provides a method of generating a video, a method of processing a video, a device and a storage medium.

According to an aspect of the present disclosure, a method of generating a video is provided, including: determining a plurality of initial prompt texts according to an initial text input by a user, where the plurality of initial prompt texts include an initial content prompt text and an initial material prompt text; determining a video content text and at least one initial object action driving data corresponding to the video content text according to the initial content prompt text; and generating an initial video according to the at least one initial object action driving data and at least one initial material corresponding to at least one initial material prompt text.

According to another aspect of the present disclosure, a method of processing a video is provided, including: determining at least one adjustment prompt text and at least one attribute adjustment information according to an adjustment text corresponding to a to-be-processed video, where the to-be-processed video corresponds to at least one to-be-adjusted material; adjusting attribute information of the at least one to-be-adjusted material corresponding to the at least one adjustment prompt text according to the at least one attribute adjustment information corresponding to the at least one adjustment prompt text, so as to obtain at least one adjusted material; and obtaining a processed video according to the at least one adjusted material.

According to another aspect of the present disclosure, an electronic device is provided, including: at least one processor; and a memory communicatively connected to the at least one processor; where the memory stores instructions executable by the at least one processor, and the instructions, when executed by the at least one processor, are configured to cause the at least one processor to perform the methods provided by the present disclosure.

According to another aspect of the present disclosure, a non-transitory computer-readable storage medium having computer instructions stored therein is provided, and the computer instructions are configured to cause a computer to perform the methods provided by the present disclosure.

It should be understood that the contents described in the section are not intended to identify key or important features of embodiments of the present disclosure, and are not intended to limit the scope of the present disclosure. Other features of the present disclosure will become easily understood through the following descriptions.

### BRIEF DESCRIPTION OF THE DRAWINGS

Accompanying drawings are used to better understand the present disclosure, and do not constitute a limitation of the present disclosure, in which:

FIG. 1 shows a schematic diagram of an exemplary system architecture to which a method and an apparatus of generating a video, a method and an apparatus of processing a video may be applied according to an embodiment of the present disclosure;

FIG. 2 shows a flowchart of a method of generating a video according to an embodiment of the present disclosure;

FIG. 3 shows a schematic diagram of script data according to an embodiment of the present disclosure;

FIG. 4 shows a schematic diagram of a plurality of tasks corresponding to a plurality of prompt texts according to an embodiment of the present disclosure;

FIG. 5 shows a schematic diagram of a method of generating a video according to an embodiment of the present disclosure;

FIG. 6A shows a schematic diagram of a visual interface according to an embodiment of the present disclosure;

FIG. 6B and FIG. 6C show schematic diagrams of different video frames of an initial video according to an embodiment of the present disclosure;

FIG. 7 shows a flowchart of a method of processing a video according to another embodiment of the present disclosure;

FIG. 8 shows a block diagram of an apparatus of generating a video according to an embodiment of the present disclosure;

FIG. 9 shows a block diagram of an apparatus of processing a video according to another embodiment of the present disclosure; and

FIG. 10 shows a block diagram of an electronic device for implementing a method of generating a video and/or a method of processing a video according to an embodiment of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those skilled in the art should achieve that various changes and modifications may be made to embodiments described herein without departing from the scope and spirit of the present disclosure. Likewise, for clarity and conciseness, descriptions of well-known functions and structures are omitted in the following description.

In order to design and produce an exquisite video that meets requirements, one or more designers, directors and actors with excellent aesthetics and rich experience need to spend a great deal of time to complete it, which may lead to a high labor cost in a video production process, especially a labor cost of professionals, and also lead to a high time cost required for a video production.

In some embodiments, a video may be generated by using a conversational large model based on natural language input by a user.

However, in a case of generating a video by using the large model, a controllability and editability of the video are insufficient. When generating a complex scene, the large model (such as sora) may be difficult to accurately simulate a physical behavior, resulting in inaccurate details of the generated video. For example, an interaction between objects is unnatural and does not follow the laws of physics, etc. Even though some large models (such as runway gen3) may generate a high-quality video, it is difficult to deal with an interaction between complex characters and objects, and the generated video is difficult to meet user desires.

In addition, in a case of generating a video by using an artificial intelligence technology, a duration of the generated video is short. As the duration of the generated video increases, there are increasing number of errors and unreasonableness in the video. For example, if a video of several minutes in length is generated by using the artificial intelligence technology, a long generation time is required, and the generated video may have a low quality, making it difficult to use an artificial intelligence-based video generation technology for a generation of a long-form video.

In addition, in a process of generating the video by using the artificial intelligence technology, general data may be used for automated video generation, which may lead to a lack of user's personalized characteristics and a low distinctiveness in the generated video, failing to meet personalized desires of the user.

In addition, the artificial intelligence-based video generation technology has a low maturity and stability, and its performance in different scenarios is quite different, especially in a complex scenario, it is difficult to generate a continuous and high-quality video. The artificial intelligence-based video generation technology has brought many conveniences and possibilities to a video creation, but a controllability, an editability, a compliance, and a personalization level thereof still need to be improved, and a hardware resource overhead is large and still needs to be further optimized.

Therefore, in order to efficiently generate a video, the present disclosure provides a method of generating a video and a method of processing a video, and a system architecture to which the methods are applied will be described below.

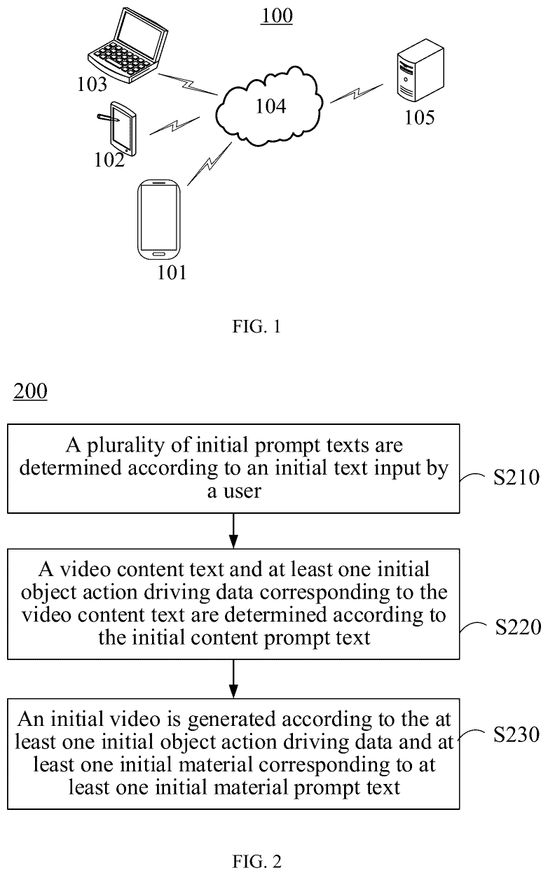

FIG. 1 shows a schematic diagram of an exemplary system architecture to which a method and an apparatus of generating a video, and a method and an apparatus of processing a video may be applied according to an embodiment of the present disclosure. It should be noted that FIG. 1 shows only an example of a system architecture to which an embodiment of the present disclosure may be applied, so as to help those skilled in the art understand the technical content of the present disclosure, but it does not mean that embodiments of the present disclosure may not be applied to other devices, systems, environments, or scenarios.

As shown in FIG. 1, a system architecture 100 according to the embodiment may include terminal devices 101, 102 and 103, a network 104 and a server 105. The network 104 is used to provide a medium of a communication link between the terminal devices 101, 102 and 103 and the server 105. The network 104 may include various connection types, such as a wired and/or wireless communication link, etc.

The terminal devices 101, 102 and 103 may be used by users to interact with the server 105 through the network 104, so as to receive or send messages, etc. The terminal devices 101, 102 and 103 may be various electronic devices having a display screen and supporting web browsing, including but not limited to a smart phone, a tablet computer, a laptop computer, a desktop computer, etc.

The server 105 may be a server providing various services, such as a background management server (for example only) that provides a support for a website browsed by the user using the terminal devices 101, 102, and 103. The background management server may analyze and process received data such as a user request, and feedback a processing result (such as a web page, information, or data, etc. obtained or generated according to the user request) to the terminal devices.

It should be noted that the method of generating a video and the method of processing a video provided in embodiments of the present disclosure may generally be performed by the server 105. Accordingly, the apparatus of generating a video and the apparatus of processing a video provided in embodiments of the present disclosure may generally be provided in the server 105. The method of generating a video and the method of processing a video provided in embodiments of the present disclosure may also be performed by a server or a server cluster that is different from the server 105 and capable of communicating with the terminal devices 101, 102 and 103 and/or the server 105. Accordingly, the apparatus of generating a video and the apparatus of processing a video provided in embodiments of the present disclosure may also be provided in the server or the server cluster that is different from the server 105 and capable of communicating with the terminal devices 101, 102 and 103 and/or the server 105.

It may be understood that the system architecture of the present disclosure has been described above, and the methods of the present disclosure will be described below.

FIG. 2 shows a flowchart of a method of generating a video according to an embodiment of the present disclosure.

As shown in FIG. 2, a method 200 of generating a video may include operations S210 to S230.

In the operation S210, a plurality of initial prompt texts are determined according to an initial text input by a user.

In embodiments of the present disclosure, the initial prompt text may be determined using various methods. For example, the initial text may be segmented. Based on a segmentation result, the initial prompt text is determined. If the initial text is “a host is introducing news”, the initial prompt text may be “host” and “news”.

In embodiments of the present disclosure, the plurality of initial prompt texts include an initial content prompt text and an initial material prompt text. For example, the initial prompt text “news” may be the initial content prompt text. The initial prompt text “host” may be the initial material prompt text.

In the operation S220, a video content text and at least one initial object action driving data corresponding to the video content text are determined according to the initial content prompt text.

In embodiments of the present disclosure, the initial object action driving data includes driving data corresponding to a mouth shape of an object. For example, based on the initial prompt text “news”, one or more news of a certain day may be obtained as the video content text. Based on a text-to-speech (TTS) technology, one or more mouth shape data corresponding to the video content text may be obtained. Based on the one or more mouth shape data, one or more initial object action driving data may be determined.

In the operation S230, an initial video is generated according to the at least one initial object action driving data and at least one initial material corresponding to at least one initial material prompt text.

For example, an initial material corresponding to the initial prompt text “host” may be a virtual avatar. The virtual avatar includes a head and a lip. The lip of the virtual avatar may be driven to perform one or more lip movements by using the initial object action driving data, so as to achieve the above one or more mouth shapes, thereby obtaining one or more video frames. The initial video may be obtained based on these video frames.

Through embodiments of the present disclosure, a video generation is achieved using the initial prompt text, which reduces a labor cost and a time cost required for the video generation. The video content text is generated using the initial content prompt text, and action driving data may be determined, so that the video text content is more consistent and coordinated with an action presented by an object in the video, thereby improving a quality of the video.

In addition, through embodiments of the present disclosure, in a case that a scene in the video is a three-dimensional scene, a production cost is greatly reduced. If the materials required for the video generatio are already prepared, a video with the three-dimensional scene may be quickly generated through text description. For low-and medium-requirement projects that require a short-term delivery, such as a virtual character live broadcast, a promotional video, a production delivery cycle may be greatly shortened to within a few days. In addition, three-dimensional scene designers may focus their efforts on material optimization and overall scene concept design, which may minimize a repetitive labor for the designers and improve an overall video quality and a video generation efficiency.

It may be understood that the method of the present disclosure has been described above, and the initial prompt text of the present disclosure will be described below.

In some embodiments, in some implementations of the above operation S210, the determining a plurality of initial prompt texts according to an initial text input by a user includes: determining initial script data according to the initial text and attribute information of the user; and determining the plurality of initial prompt texts according to the initial script data.

In embodiments of the present disclosure, the attribute information of the user includes information such as an industry in which the user belongs to, an actual application scenario, etc. For example, when the user uses an artificial intelligence product for the first time, he or she may input a text “help me generate a video with this digital character” in an input box of a visual interface of the product. Next, after the user authorizes, the attribute information authorized by the user may be obtained.

In embodiments of the present disclosure, the plurality of initial prompt texts may be determined by using a large model according to the initial text and attribute information of the user. The large model may be fine-tuned by using a plurality of sample texts and a plurality of preset prompt texts. The initial prompt text is determined from the plurality of preset prompt texts by using the large model. The large model may be a large language model (LLM). The preset prompt text may be a standardized prompt text. The sample texts may be historical texts input into the large model by users, or historical texts input into the large model by a plurality of users with similar attributes, or texts with high similarity generated based on the historical texts input by the users, which will not be limited in the present disclosure. The large model may be a conversational large model such as Ernie Bot, etc. Through embodiments of the present disclosure, by using the conversational large model, a short natural language text prompt word may be used to quickly generate a video based on a produced material in a material production platform. The large model is fine-tuned using the preset prompt text, and the preset prompt text may correspond to an identification text of a material, so that the fine-tuned large model may quickly determine, from a plurality of materials, a material corresponding to the initial prompt text or an adjusted prompt text.

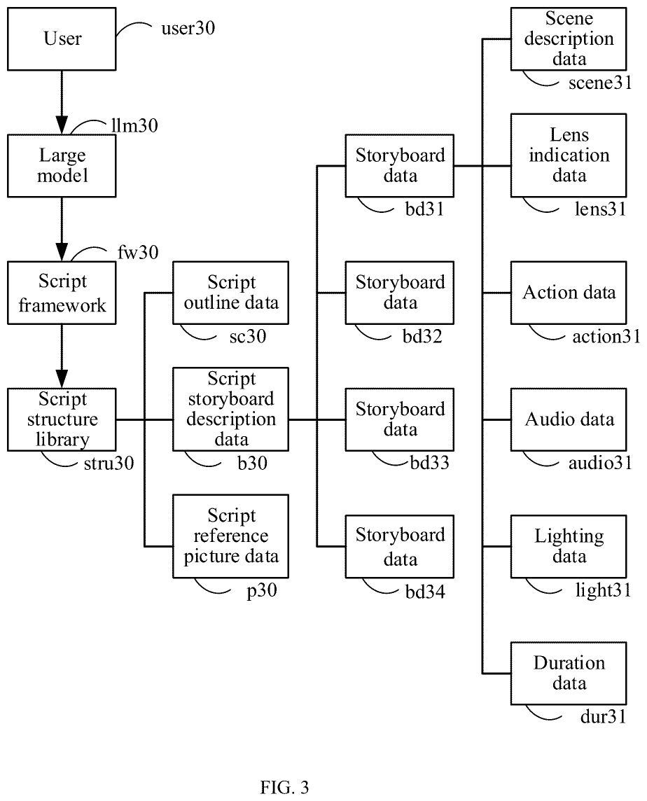

In embodiments of the present disclosure, the initial script data includes at least one of initial script outline data, initial script storyboard description data or initial script reference picture data, which will be described below with reference to FIG. 3.

FIG. 3 shows a schematic diagram of script data according to an embodiment of the present disclosure.

As shown in FIG. 3, a user user30 may input a natural language text “a host is introducing news” into a large model llm30. The large model llm30 may disassemble the natural language text to obtain a plurality of disassembly results. The plurality of disassembly results may include “host”, “news”, etc. According to the plurality of disassembly results, a script structure is determined from a script structure library stru30 by using a script framework fw30 corresponding to the attribute information of the user. The script structure may include at least one of an outline, a storyboard, or a reference picture. Accordingly, the script data determined using the script structure may include at least one of script outline data sc30, script storyboard description data b30, or script reference picture data p30.

The script outline data sc30 is equivalent to a script outline provided by a screenwriter. The script outline data sc30 may include a script outline text “a host is introducing news”.

The script storyboard description data b30 may correspond to a script storyboard description text “the lens advances from a panoramic view, switches to a close-up view and then switches to a medium view for a fixed shot”. The script storyboard description text may correspond to a camera lens movement method commonly used in a news scene. The script storyboard description data may also correspond to one or more storyboard data. As shown in FIG. 3, one or more storyboard data may include storyboard data bd31, storyboard data bd32, storyboard data bd33 and storyboard data bd34, etc. The storyboard data bd31 may include at least one of scene description data scene31, lens indication data lens31, action data action31, audio data audio31, lighting data light31 or duration data dur31. The scene description data scene31 may indicate a scene type, a surrounding layout, etc. The lens indication data lens31 may indicate a lens type and a lens movement method. The action data action31 may indicate a head action of an object and a body action of an object. The audio data audio31 may indicate a sound effect and a background music. The lighting data light31 may indicate character light and scene light. The duration data dur31 may indicate a duration of a storyboard.

The script reference picture data p30 includes video size data, focal length data, depth of field data, and action rhythm data. The action rhythm data 31 may indicate a speed at which the object performs the above body action. The script reference picture data p30 may correspond to a script reference picture description text “a composition of 16:9, an overall slow rhythm, etc.”

It may be understood that, if the above natural language text is used as the initial text, the above script data may be used as the initial script data. The script outline data sc30, the script storyboard description data b30 and the script reference picture data p30 may be used as the initial script outline data, the initial script storyboard description data and the initial script reference picture data, respectively. The initial script storyboard description data corresponds to at least one initial storyboard data, and the initial storyboard data includes at least one of initial scene description data, initial lens indication data, initial action data, initial audio data, initial lighting data or initial duration data. The initial script reference picture data includes at least one of initial video size data, initial focal length data or initial depth of field data.

Through embodiments of the present disclosure, a short natural language text may be used to generate a highly professional script (script outline, reference pictures, storyboards, etc.) that is matched with a user attributes, so as to quickly generate a video based on the script.

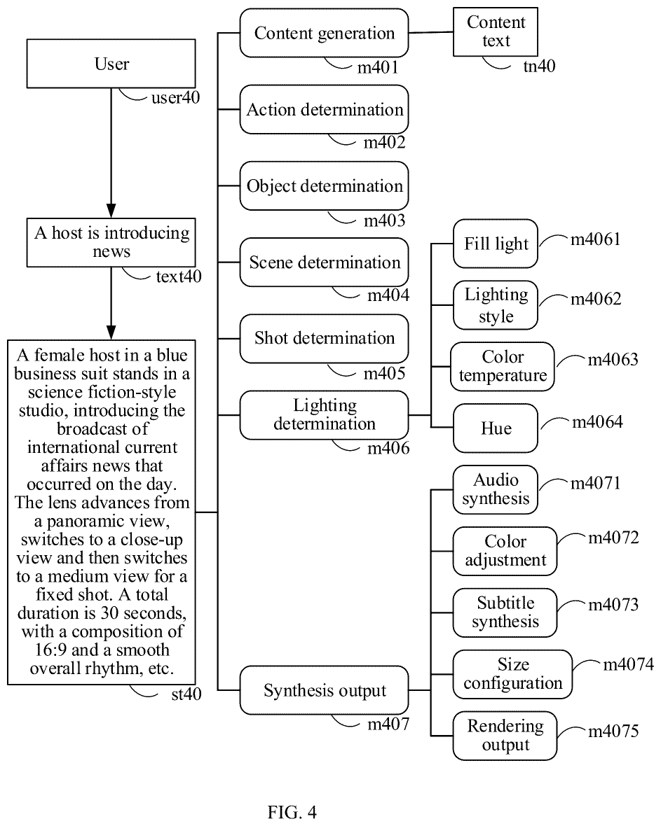

It may be understood that the initial script data of the present disclosure has been described above, and the plurality of initial prompt texts will be described below with reference to FIG. 4.

FIG. 4 shows a schematic diagram of a plurality of tasks corresponding to a plurality of prompt texts according to an embodiment of the present disclosure.

As shown in FIG. 4, a user user40 may provide a natural language text 40. The natural language text 40 may be “a host is introducing news”.

In embodiments of the present disclosure, the plurality of initial prompt texts may be determined according to the initial script data. For example, based on the above-described script outline text, script storyboard description text and script reference picture description text, a script text st40 may be obtained by processing with a large model. The script text st40 may be “a female host in a blue business suit stands in a science fiction-style studio, introducing the broadcast of international current affairs news that occurred on the day. The lens advances from a panoramic view, switches to a close-up view and then switches to a medium view for a fixed shot. A total duration is 30 seconds, with a composition of 16:9 and a smooth overall rhythm, etc.”. It may be understood that, on the basis of the script outline text, the above-described script text may be obtained by adding description texts related to a scene, an object, etc. A plurality of prompt texts may be determined based on the script text. The plurality of prompt texts may correspond to a plurality of tasks. The plurality of tasks may include a content generation task m401, an action generation task m402, an object determination task m403, a scene determination task m404, a shot determination task m405, a lighting determination task m406, and a synthesis output task m407.

In embodiments of the present disclosure, the plurality of prompt texts may include a content prompt text. The content prompt text may be “international current affairs news that occurred on the day”. The content prompt text may be used as an initial content prompt text.

In embodiments of the present disclosure, an initial content text may be generated by using the large model according to the initial content prompt text. For example, in order to perform a content generation task m401, the large model may search for international current affairs news according to the date and generate a content text tn40. The content text tn40 may be “this afternoon, a cabin-opening activity was held for a returner of a lunar exploration project, which brought a successful conclusion to an implementation phase of a lunar exploration mission project. According to a report by the broadcasting company of country A yesterday, a director of the health bureau of a certain country announced that there are currently no major public health incidents. The president of country B signed a decree to approve a decision of unit C on the use of drones. The decree has been published on a website of the presidential palace of country B”. The content text may be used as the initial content text.

For another example, after performing the action generation task m402, body action driving data and head action driving data of an object may be obtained. The body action driving data may correspond to an overall action, an action above a waist, an action of feet, and an action of hands of the object. After performing the object determination task m403, for example, a digital character may be determined as an object. A body and a head of the object may be driven by the above-described body action driving data and head action driving data respectively to perform a related action. After performing the scene determination task m404, a scene in which the object is located may be determined. In order to perform the shot determination task m405, shot description information may be determined based on a position of the object. The shot description information is related to a movement method of the lens. The position of the object includes a position corresponding to a head, eyes, a mouth, a waist, a left hand, a right hand, a left foot, a right foot, a left leg and a right leg of the object.

The lighting determination task m406 may include one or more of a fill light task m4061, a lighting style determination task m4062, a color temperature determination task m4063, a hue determination task m4064, etc. An execution result of the fill light task m4061 may correspond to fill light methods such as front light, back light, side light, side front light, side back light, top light, edge light, etc. An execution result of the lighting style determination task m4062 may correspond to a plurality of lighting styles. The plurality of lighting styles may include a flat light style, a horror style, a 1920s style, a cyber style, etc. An execution result of the color temperature determination task m4063 is related to warm white temperature, pure white temperature, cold white temperature, etc. An execution result of the hue determination task m4064 corresponds to hues such as red, blue, etc.

The synthesis output task m407 may include one or more of an audio synthesis task m4071, a color adjustment task m4072, a subtitle synthesis task m4073, a size configuration task m4074, a rendering output task m4075, etc. Based on the audio synthesis task m4071, audios such as a background sound, an environmental sound, a sound effect, etc. may be synthesized into an audio file. Based on the color adjustment task m4072, an overall color tone of a video may be adjusted. Based on the subtitle synthesis task m4073, one or more of subtitle embedding, font setting, and subtitle special effect embedding processing may be performed. The size configuration task m4074 corresponds to a plurality of video sizes. The plurality of video sizes include 16:9, 4:3, etc. The rendering output task m4075 corresponds to one or more video frames, and also corresponds to a format of the video. A file format of the video frame may be a Joint Photographic Experts Group (JPEG) format, a Portable Network Graphics (PNG) format, etc.

It may be understood that the plurality of initial prompt texts have been described above, and the method of generating a video will be further described below.

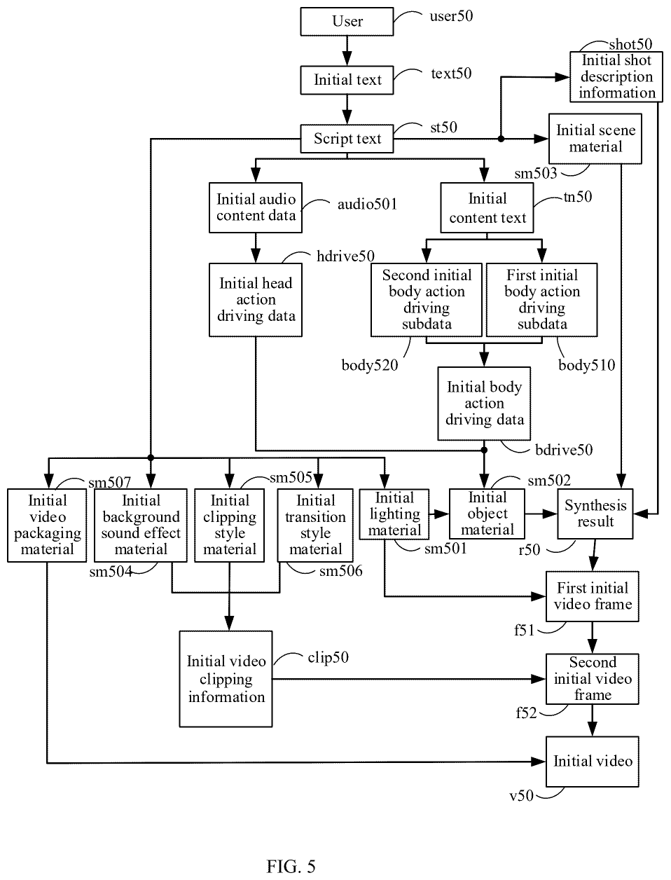

FIG. 5 shows a schematic diagram of a method of generating a video according to an embodiment of the present disclosure.

As shown in FIG. 5, a user may input a natural language text as an initial text text50. Initial script data may be determined based on the initial text text50. The initial script data may include an initial script text st50. The plurality of initial prompt texts may be determined based on the initial script text st50. The plurality of initial prompt texts may include an initial content prompt text. It may be understood that the above descriptions of the natural language text text40 and the script text st40 are also applicable to the initial text text50 and the initial script text st50. Some methods of determining object action driving data will be described below.

In embodiments of the present disclosure, in some implementations of the above operation S220, the determining a video content text and at least one initial object action driving data corresponding to the video content text according to the initial content prompt text includes: generating an initial content text according to the initial content prompt text; and determining initial audio content data corresponding to the initial content text, time information and the at least one initial object action driving data. For example, an initial audio content data audio501 corresponding to an initial content text tn50 may be determined by using the above-described text-to-speech technology. The initial audio content data audio501 may correspond to time information. The time information is related to a duration of the initial audio content. Some methods for determining the object action driving data will be described below. It may be understood that the above description of the initial content text tn40 is also applicable to the initial content text tn50, which will not be repeated in the present disclosure.

In some embodiments, the determining initial audio content data corresponding to the initial content text, time information and the at least one initial object action driving data includes: determining initial head action driving data according to the initial audio content data. For example, initial head action driving data hdrive50 may correspond to a mouth-shape action of the initial audio content data.

In some embodiments, the determining initial audio content data corresponding to the initial content text, time information and the at least one initial object action driving data includes: determining initial body action driving data according to the initial content text.

In embodiments of the present disclosure, the determining initial body action driving data according to the initial content text includes: determining at least one initial content subtext of the initial content text according to a text structure of the initial content text; and determining at least one first initial body action driving subdata corresponding to the at least one initial content subtext. For example, the text structure may indicate segmentation information of a text. At least one content subtext of the content text tn50 may include “this afternoon, a cabin-opening activity was held for a returner of a lunar exploration project, which brought a successful conclusion to an implementation phase of a lunar exploration mission project”, “according to a report by the broadcasting company of country A yesterday, a director of the health bureau of a certain country announced that there are currently no major public health incidents”, and “the president of country B signed a decree to approve a decision of unit C on the use of drones. The decree has been published on a website of the presidential palace of country B”. Different content subtexts may correspond to different actions. Therefore, at least one action material may be determined from a plurality of action materials as at least one first action material corresponding to the content subtext. Driving data corresponding to the first action material may be used as first initial body action driving subdata body510.

In embodiments of the present disclosure, the determining initial body action driving data according to the initial content text includes: determining at least one second initial body action driving subdata corresponding to the initial content text according to the time information. For example, according to time information corresponding to the above-described initial audio content data audio501, at least one second action material corresponding to an entire initial content text may be determined from the plurality of action materials. The second action material may increase a richness of an object action. Driving data corresponding to the at least one second action material may be used as second initial body action driving subdata body520.

In embodiments of the present disclosure, the determining initial body action driving data according to the initial content text includes: determining at least one initial body action driving data according to the at least one first initial body action driving subdata and the at least one second initial body action driving subdata. As shown in FIG. 5, at least one initial body action driving data bdrive50 may be determined by fusing at least one first initial body action driving subdata body510 and at least one second initial body action driving subdata body520.

In some embodiments, the determining initial audio content data corresponding to the initial content text, time information and the at least one initial object action driving data includes: determining the at least one initial object action driving data according to the initial head action driving data and the initial body action driving data. As shown in FIG. 5, the initial object action driving data may be determined according to the initial head action driving data hdrive50 and the at least one initial body action driving data bdrive50.

It may be understood that some methods of determining the initial object action driving data have been described above, and some methods of generating a video will be described below.

In some embodiments, at least one initial material prompt text includes an initial style material prompt text. In some implementations of the above-described operation S220, the generating an initial video according to the at least one initial object action driving data and at least one initial material corresponding to at least one initial material prompt text includes: determining an initial object material according to an initial lighting material corresponding to the initial style material prompt text and the at least one initial object action driving data. As shown in FIG. 5, the plurality of initial prompt texts determined according to the initial script text st50 may include the initial style material prompt text. An initial lighting material sm501 may be determined based on the initial style material prompt text. An initial object material sm502 may be determined according to the initial lighting material sm501, a virtual avatar corresponding to the initial prompt text “host” and the at least one initial object action driving data. The initial video may be generated according to the initial object material.

In embodiments of the present disclosure, the plurality of initial prompt texts further include at least one of an initial scene material prompt text and an initial shot description prompt text. For example, the initial scene material prompt text may be “studio”. A plurality of scene materials may include an indoor scene material and an outdoor scene materials. The outdoor scene material may correspond to scenes such as a mountain, a grassland, a city rooftop, a tree house in the woods, etc., and may also correspond to different weather materials. The different weather materials include a sunny outdoor scene material, a rainy outdoor scene material, a snowy outdoor scene material, etc. The indoor scene material may include an office material, a studio material, a classroom material, etc. An initial scene material sm503 corresponding to the initial scene material prompt text “studio” may be the above-described studio material. The initial shot description prompt text may correspond to shot description information shot50. The shot description information may indicate an action type, a focal length, an angle of the shot, etc.

In embodiments of the present disclosure, the generating the initial video according to the initial object material includes: obtaining a plurality of first initial video frames according to the initial object material, the initial lighting material and an initial scene material corresponding to the initial scene material prompt text. For example, the plurality of first initial video frames may be obtained according to the initial object material, the initial lighting material, the initial scene material and initial shot description information corresponding to the initial shot description prompt text. As shown in FIG. 5, the initial object material sm502 may correspond to a plurality of different actions. A plurality of synthesis results r50 corresponding to a plurality of actions may be determined according to the initial object material sm502, the initial scene material sm503, and the shot description information shot50. A plurality of first initial video frames f51 may be obtained according to the plurality of synthesis results r50 and the initial lighting material sm501. The initial video may be generated according to the plurality of first initial video frames f51. It may be understood that the initial video may be directly determined according to the plurality of first initial video frames. The initial video may also be generated by selecting one or more from the plurality of first initial video frames, which will be described below.

In embodiments of the present disclosure, the generating the initial video according to the plurality of first initial video frames includes: determining initial video clipping information according to at least one of the initial audio content data corresponding to the initial content text, an initial background sound effect material corresponding to the initial style material prompt text, an initial clipping style material corresponding to the initial style material prompt text or an initial transition style material corresponding to the initial style material prompt text. As shown in FIG. 5, an initial background sound effect material sm504, an initial clipping style material sm505, and an initial transition style material sm506 may be determined according to the initial style material prompt text, so that initial video clipping information clip50 may be determined. The initial video clipping information may include one or more clipping conditions. The clipping condition may be that actions of different frames are the same. One of two video frames that meet the clipping condition may be deleted. It may be understood that the clipping condition may also include other conditions, which will not be limited in the present disclosure.

In embodiments of the present disclosure, the generating the initial video according to the plurality of first initial video frames includes: obtaining at least one second initial video frame according to the initial video clipping information and the plurality of first initial video frames. For example, at least one second video frame f52 may be obtained according to the initial video clip information clip50 and the plurality of first initial video frames f51. Next, the initial video may be generated according to the at least one second initial video frame.

In embodiments of the present disclosure, the generating the initial video according to the at least one second initial video frame includes: packaging the at least one second initial video frame according to an initial video packaging material corresponding to the initial style material prompt text, so as to generate the initial video. As shown in FIG. 5, the initial style material prompt text may correspond to an initial video packaging material sm507. The initial video packaging material sm507 may indicate a format of video packaging. An initial video v50 may be obtained by packaging the at least one second initial video frame f52 according to an initial video packaging material package50.

It may be understood that the method in the present disclosure has been described above, and a method of post-processing the initial video of the present disclosure will be further described below.

In some embodiments, a sequence tag of each of a plurality of video frames in the initial video may be determined to adjust an order of the video frames. For example, the content subtext may correspond to the plurality of video frames. An order of the video contents corresponding to different content subtexts in a video may be changed according to the order of the video frames.

In some embodiments, one or more video frames in the initial video that meet a deletion condition may be deleted. The deletion condition may include a presence of at least one of an action error, a repeated action, stillness, etc.

In some embodiments, a playback rate of the initial video may be adjusted.

In some embodiments, an external application programming interface (API) may be called to render a tile image. The tile image may be an image such as an icon, etc. presented in the video. An external audio generation application programming interface may also be called to adjust an audio or sound effect of the initial video. If a subtitle exits in the initial video, a font format of the subtitle may also be adjusted.

It may be understood that the method of post-processing the video has been described above, and the initial video will be described below.

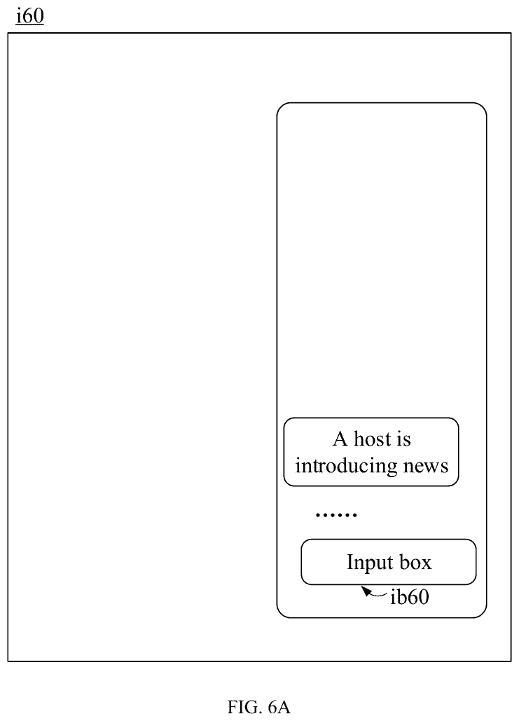

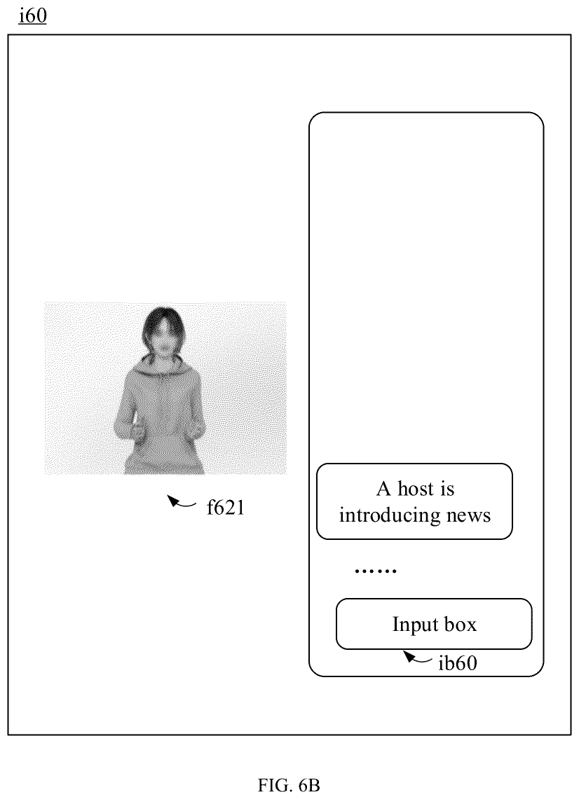

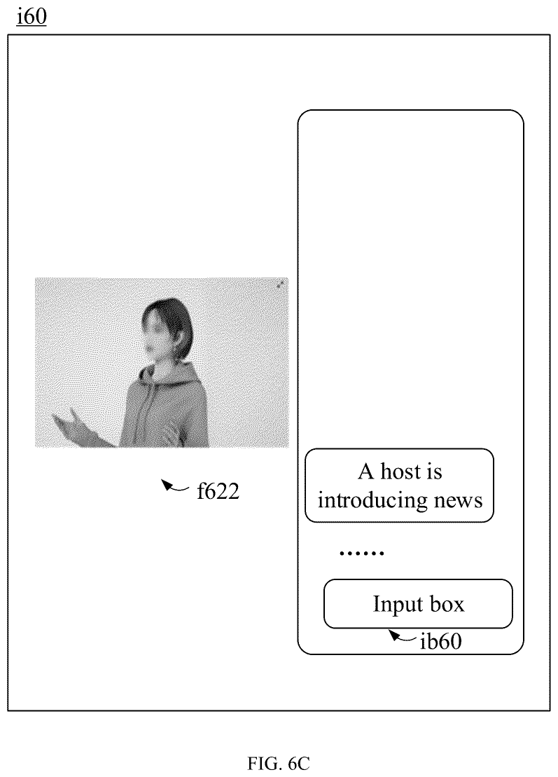

In some embodiments, the generating an initial video includes: presenting the initial video on a visual interface. This will be described below with reference to FIG. 6A to FIG. 6C.

FIG. 6A shows a schematic diagram of a visual interface according to an embodiment of the present disclosure.

As shown in FIG. 6A, a visual interface i60 may include an input box ib60. The user inputs an initial text “a host is introducing news” using the input box ib60. Next, the initial video may be generated based on the initial text and presented on the visual interface i60.

FIG. 6B and FIG. 6C show schematic diagrams of different video frames of an initial video according to an embodiment of the present disclosure.

As shown in FIG. 6B, at a first moment, the visual interface i60 presents a video frame f621 of the initial video. As shown in FIG. 6C, at a second moment, the visual interface i60 presents a video frame f622 of the initial video. In the video frames f621 and f622, actions of an object are different.

It may be understood that the method of generating a video in the present disclosure has been described above, and an application scenario of the method will be further described below.

In some embodiments, a video for social media may be produced by using the above methods. For example, by using the above methods and a conversational large model, the user may quickly obtain an interesting and attractive video for presentation on a social media platform and convenient daily sharing.

In some embodiments, a corporate advertising and marketing video may be produced by using the above methods. For example, by using the above methods and the conversational large model, relevant personnel of the enterprise may easily produce a promotional video to show characteristics and brand concepts of an enterprise product, so as to improve an advertising effect and attract more potential customers.

In some embodiments, an educational training video may be produced by using the above methods. For example, by using the above methods and the conversational large model, a teacher may transform teaching content into a vivid video, so as to improve a learning mood of a student and enable the student to learn knowledge more intuitively.

In some embodiments, a news report video may be produced by using the above methods. For example, by using the above methods and the conversational large model, a reporter, a director, etc. may quickly produce a news report video, so as to improve a speed and an influence of news dissemination, and enable a viewer to understand a news event more intuitively.

In some embodiments, an entertainment video may be produced by using the above methods. For example, by using the above methods and the conversational large model, in an entertainment and leisure occasion, the user may make a home movie, a travel record, etc., and record his/her lives in a form of video.

In some embodiments, an e-commerce operation video may be produced by using the above methods. For example, in an e-commerce industry, by using the above methods and the conversational large model, an anchor, a merchant, etc. may produce a product present video to attract more customers to buy goods, so as to improve a profitability.

In some embodiments, a stylized animation video may be produced by using the above methods. For example, by using the above methods and the conversational large model, an animation creator may quickly produce an animation clip, so as to greatly improve an animation production efficiency, and bring a rich visual experience to an audience.

Through embodiments of the present disclosure, in a video production process, starting entirely from the user's perspective, the large model is used in each key link to input a text prompt word to assist the user to quickly obtain a desired effect in each key link in accordance with a general video commercial production process. In embodiments of the present disclosure, the large model may be Ernie Bot, which may support a user's full Chinese input and provide a more accurately understanding of Chinese semantics.

It may be understood that the application scenario of the method of generating a video of the present disclosure has been described above, and the method of processing a video of the present disclosure will be described below.

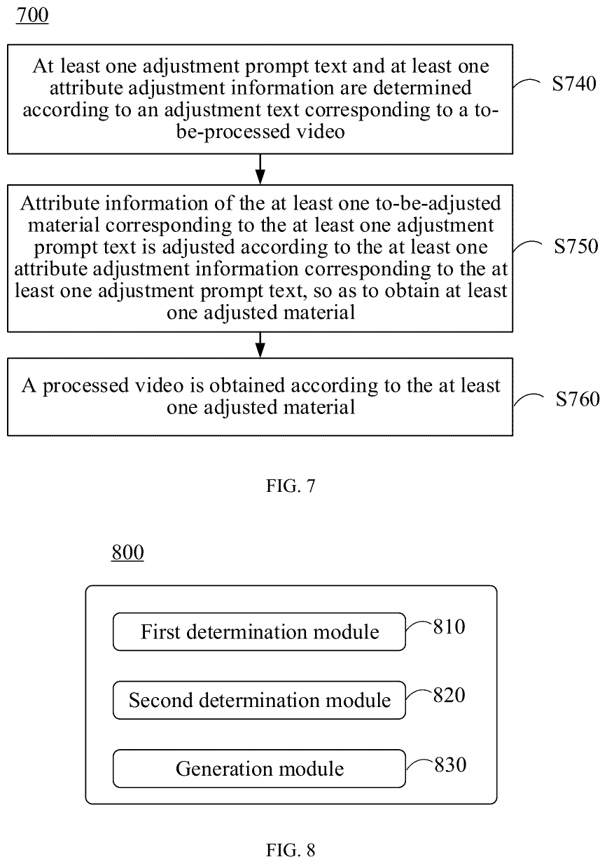

FIG. 7 shows a flowchart of a method of processing a video according to another embodiment of the present disclosure.

As shown in FIG. 7, a method 700 of processing a video may include operations S740 to S760.

In the operation S740, at least one adjustment prompt text and at least one attribute adjustment information are determined according to an adjustment text corresponding to a to-be-processed video.

In embodiments of the present disclosure, the to-be-processed video may be a generated video. For example, the to-be-processed video may be the initial video v50 as described above.

In embodiments of the present disclosure, the to-be-processed video corresponds to at least one to-be-adjusted material. For example, the to-be-processed video may be generated using at least one material. Any material in a to-be-processed image may be used as a to-be-adjusted material. The above-described initial scene material may be used as a to-be-adjusted material. Attributes of a material may include a size, a position, a color, a content, etc.

In embodiments of the present disclosure, an adjustment text may be input by the user for the generated video. For example, the adjustment text may be “please help me change a scene to a blue one”.

In embodiments of the present disclosure, the adjustment prompt text and the attribute adjustment information may be determined using various methods. For example, the adjustment text may be segmented. Based on a segmentation result, the adjustment prompt text and the attribute adjustment information are determined. Taking a first noun as the adjustment prompt text and determining the attribute adjustment information based on a verb and related words thereof, “scene” may be used as an adjustment prompt text, and the attribute adjustment information may be determined based on “change to a blue one”.

In the operation S750, attribute information of the at least one to-be-adjusted material corresponding to the at least one adjustment prompt text is adjusted according to the at least one attribute adjustment information corresponding to the at least one adjustment prompt text, so as to obtain at least one adjusted material.

In embodiments of the present disclosure, the adjustment prompt text may correspond to one or more attribute adjustment information. The adjustment prompt text may also correspond to one or more to-be-adjusted materials. For example, the adjustment prompt text “scene” may correspond to a scene material, and also correspond to the attribute adjustment information determined based on “change to a blue one”. A color of the scene material may be adjusted to blue, so as to obtain an adjusted scene material.

In the operation S760, a processed video is obtained according to the at least one adjusted material.

In embodiments of the present disclosure, a video may be generated based on an adjusted material and an unadjusted material, so as to obtain the processed video. Alternatively, a material corresponding to the adjustment prompt text may be replaced with the adjusted material, so as to obtain the processed video.

Through embodiments of the present disclosure, the material is adjusted by using the adjustment prompt text and the attribute adjustment information, so as to achieve a specified modification of a video and reduce a labor cost and a time cost required for video generation. In addition, the video is modified through an adjustment text input by the user, which may reduce a threshold for the specified modification. A user who does not have a professional artistic ability may also obtain an exquisite video through adjustment, which effectively improves a user experience.

In some embodiments, the to-be-processed video is obtained according to an initial video, and the adjusting attribute information of the at least one to-be-adjusted material corresponding to the at least one adjustment prompt text includes: presenting, on a visual interface, an identification text of the to-be-adjusted material corresponding to the adjustment prompt text, in response to determining the to-be-adjusted material corresponding to the adjustment prompt text from the at least one to-be-adjusted material.

In some embodiments, the determining at least one adjustment prompt text and at least one attribute adjustment information according to an adjustment text corresponding to a to-be-processed video includes: determining the at least one adjustment prompt text and at least one attribute adjustment information by using a large model according to the adjustment text. For example, the adjustment prompt text “scene” and the attribute adjustment information “change to a blue one” may be determined by using the above-described large model llm30. Through embodiments of the present disclosure, a style and a tone of a video are quickly changed in real time by using a conversational large model according to an input text prompt word.

In some embodiments, the to-be-processed video is obtained according to an initial video, and the adjusting attribute information of the at least one to-be-adjusted material corresponding to the at least one adjustment prompt text includes: presenting, on a visual interface, an identification text of the to-be-adjusted material corresponding to the adjustment prompt text, in response to determining the to-be-adjusted material corresponding to the adjustment prompt text from the at least one to-be-adjusted material. For example, the to-be-processed material used in generating the initial video v50 may be used as the to-be-adjusted material. From a plurality of to-be-adjusted materials, a to-be-adjusted material corresponding to the adjustment prompt text “scene” may be determined. The to-be-adjusted material may be the above-described initial scene material. A text “successfully located scene” may be presented on the visual interface to present an identification text “scene” of the to-be-adjusted material. Through embodiments of the present disclosure, an identification text of the material corresponding to the adjustment prompt text may be presented on the visual interface, so that the user may obtain a standard and normative text that describes a material in the video, which is helpful to improve an efficiency of video adjustment and further improve a user experience.

In embodiments of the present disclosure, the adjusting attribute information of the at least one to-be-adjusted material corresponding to the at least one adjustment prompt text according to the at least one attribute adjustment information corresponding to the at least one adjustment prompt text includes: adjusting attribute information of the to-be-adjusted material corresponding to the adjustment prompt text according to the attribute adjustment information corresponding to the adjustment prompt text. For example, according to the attribute adjustment information “change to a blue one” corresponding to the adjustment prompt text “scene”, a blue scene may be obtained as the adjusted material by adjusting the scene material to a blue one.

In some embodiments, the obtaining a processed video according to the at least one adjusted material includes: presenting the processed video on a visual interface. For example, the processed video may be presented on the visual interface.

It may be understood that the methods of the present disclosure have been described above, and apparatuses of the present disclosure will be described below.

FIG. 8 shows a block diagram of an apparatus of generating a video according to an embodiment of the present disclosure.

As shown in FIG. 8, an apparatus 800 of generating a video may include a first determination module 810, a second determination module 820 and a generation module 830.

The first determination module 810 is used to determine a plurality of initial prompt texts according to an initial text input by a user. The plurality of initial prompt texts include an initial content prompt text and an initial material prompt text.

The second determination module 820 is used to determine a video content text and at least one initial object action driving data corresponding to the video content text according to the initial content prompt text.

The generation module 830 is used to generate an initial video according to the at least one initial object action driving data and at least one initial material corresponding to at least one initial material prompt text.

In some embodiments, the first determination module includes: a first determination submodule used to determine initial script data according to the initial text and attribute information of the user; and a second determination submodule used to determine the plurality of initial prompt texts according to the initial script data.

In some embodiments, the initial script data includes at least one of initial script outline data, initial script storyboard description data or initial script reference picture data. The initial script storyboard description data corresponds to at least one initial storyboard data, and the initial storyboard data includes at least one of initial scene description data, initial lens indication data, initial action data, initial audio data, initial lighting data or initial duration data. The initial script reference picture data includes at least one of initial video size data, initial focal length data or initial depth of field data.

In some embodiments, the second determination module includes: a first generation submodule used to generate an initial content text according to the initial content prompt text; and a third determination submodule used to determine initial audio content data corresponding to the initial content text, time information and the at least one initial object action driving data.

In some embodiments, the third determination submodule includes: a first determination unit used to determine initial head action driving data according to the initial audio content data; a second determination unit used to initial body action driving data according to the initial content text; and a third determination unit used to determine the at least one initial object action driving data according to the initial head action driving data and the initial body action driving data.

In some embodiments, the second determination unit includes: a first determination subunit used to determine at least one initial content subtext of the initial content text according to a text structure of the initial content text; a second determination subunit used to determine at least one first initial body action driving subdata corresponding to the at least one initial content subtext; a third determination subunit used to determine at least one second initial body action driving subdata corresponding to the initial content text according to the time information; and a fourth determination subunit used to determine at least one initial body action driving data according to the at least one first initial body action driving data and the at least one second initial body action driving data.

In some embodiments, the at least one initial material prompt text includes an initial style material prompt text. The generation module includes: a fourth determination submodule used to determine an initial object material according to an initial lighting material corresponding to the initial style material prompt text and the at least one initial object action driving data; and a second generation submodule used to generate the initial video according to the initial object material.

In some embodiments, the at least one initial material prompt text further includes an initial scene material prompt text. The second generation submodule includes: a first obtaining unit used to obtain a plurality of first initial video frames according to the initial object material, the initial lighting material and an initial scene material corresponding to the initial scene material prompt text; and a first generation unit used to generate the initial video according to the plurality of first initial video frames.

In some embodiments, the plurality of initial prompt texts further include an initial shot description prompt text. The first obtaining unit is further used to: obtain the plurality of first initial video frames according to the initial object material, the initial lighting material, the initial scene material and initial shot description information corresponding to the initial shot description prompt text.

In some embodiments, the at least one initial material prompt text further includes the initial style material prompt text, and the first generation unit includes: a fifth determination subunit used to determine initial video clipping information according to at least one of the initial audio content data corresponding to the initial content text, an initial background sound effect material corresponding to the initial style material prompt text, an initial clipping style material corresponding to the initial style material prompt text or an initial transition style material corresponding to the initial style material prompt text; a first obtaining subunit used to obtain at least one second initial video frame according to the initial video clipping information and the plurality of first initial video frames; and a generation subunit used to generate the initial video according to the at least one second initial video frame.

In some embodiments, the generation subunit is further used to: package the at least one second initial video frame according to an initial video packaging material corresponding to the initial style material prompt text, so as to generate the initial video.

In some embodiments, the first determination module is further used to: determine the plurality of initial prompt texts by using a large model according to the initial text and attribute information of the user. The large model is fine-tuned by using a plurality of sample texts and a plurality of preset prompt texts. The initial prompt text is determined from a plurality of preset prompt texts by using the large model.

In some embodiments, the generation module includes: a first presentation submodule used to present the initial video on a visual interface.

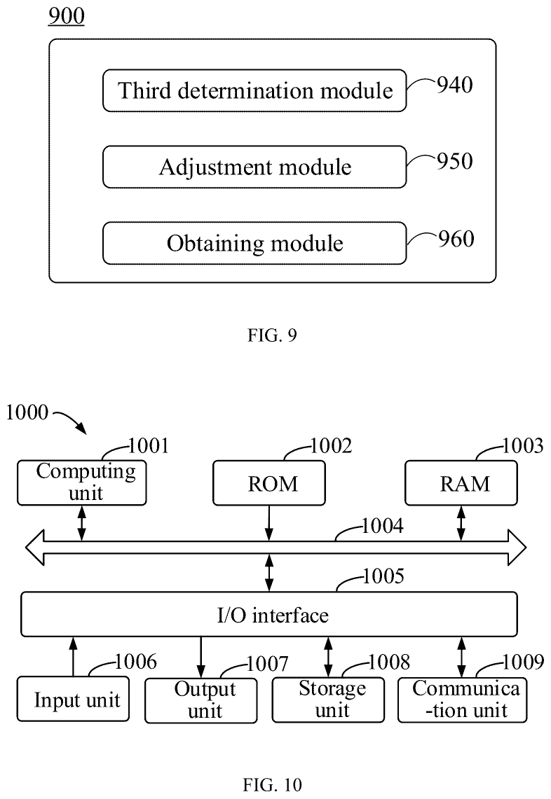

FIG. 9 shows a block diagram of an apparatus of processing a video according to another embodiment of the present disclosure.

As shown in FIG. 9, an apparatus 900 of processing a video may include a third determination module 940, an adjustment module 950, and an obtaining module 960.

The third determination module 940 is used to determine at least one adjustment prompt text and at least one attribute adjustment information according to an adjustment text corresponding to a to-be-processed video. The to-be-processed video corresponds to at least one to-be-adjusted material.

The adjustment module 950 is used to adjust attribute information of the at least one to-be-adjusted material corresponding to the at least one adjustment prompt text according to the at least one attribute adjustment information corresponding to the at least one adjustment prompt text, so as to obtain at least one adjusted material.

The obtaining module 960 is used to obtain a processed video according to the at least one adjusted material.

In some embodiments, the to-be-processed video is obtained based on the initial video, and the adjustment module includes: a second presentation submodule used to present, in response to determining the to-be-adjusted material corresponding to the adjustment prompt text from the at least one to-be-adjusted material, an identification text of the to-be-adjusted material corresponding to the adjustment prompt text on a visual interface.

In some embodiments, the obtaining module includes: a third presentation submodule used to present the processed video on a visual interface.

In some embodiments, the third determination module is further used to: determine the at least one adjustment prompt text and at least one attribute adjustment information by using a large model according to the adjustment text.

In the technical solution of the present disclosure, an acquisition, a storage, a use, a processing, a transmission, a provision and a disclosure of position information involved comply with provisions of relevant laws and regulations, and do not violate public order and good custom.

According to embodiments of the present disclosure, the present disclosure further provides an electronic device, a readable storage medium and a computer program product.

FIG. 10 shows a schematic block diagram of an exemplary electronic device 1000 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read-only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as presents or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and steps described above, such as the method of generating a video or the method of processing a video. For example, in some embodiments, the method of generating a video or the method of processing a video may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the method of generating a video or the method of processing a video described above. Alternatively, in other embodiments, the computing unit 1001 may be used to perform the method of generating a video or the method of processing a video by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, so that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read-only memory (CD-ROM), an optical storage device, a magnetic storage device, or any suitable combination of the above.

In order to provide interaction with the user, the systems and technologies described here may be implemented on a computer including a display device (for example, a cathode ray tube (CRT) or liquid crystal display (LCD) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-described specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of generating a video, comprising:
determining a plurality of initial prompt texts according to an initial text input by a user, the plurality of initial prompt texts comprising an initial content prompt text and an initial material prompt text;
determining a video content text and at least one initial object action driving data corresponding to the video content text according to the initial content prompt text; and
generating an initial video according to the at least one initial object action driving data and at least one initial material corresponding to at least one initial material prompt text.

2. The method according to claim 1, wherein the determining a plurality of initial prompt texts according to an initial text input by a user comprises:
determining initial script data according to the initial text and attribute information of the user; and
determining the plurality of initial prompt texts according to the initial script data.

3. The method according to claim 2, wherein the initial script data comprises at least one of initial script outline data, initial script storyboard description data or initial script reference picture data,
the initial script storyboard description data corresponds to at least one initial storyboard data, and the initial storyboard data comprises at least one of initial scene description data, initial lens indication data, initial action data, initial audio data, initial lighting data or initial duration data; and
the initial script reference picture data comprises at least one of initial video size data, initial focal length data or initial depth of field data.

4. The method according to claim 1, wherein the determining a video content text and at least one initial object action driving data corresponding to the video content text according to the initial content prompt text comprises:
generating an initial content text according to the initial content prompt text; and
determining initial audio content data corresponding to the initial content text, time information and the at least one initial object action driving data.

5. The method according to claim 4, wherein the determining initial audio content data corresponding to the initial content text, time information and the at least one initial object action driving data comprises:
determining initial head action driving data according to the initial audio content data;
determining initial body action driving data according to the initial content text; and
determining the at least one initial object action driving data according to the initial head action driving data and the initial body action driving data.

6. The method according to claim 5, wherein the determining initial body action driving data according to the initial content text comprises:
determining at least one initial content subtext of the initial content text according to a text structure of the initial content text;
determining at least one first initial body action driving subdata corresponding to the at least one initial content subtext;
determining at least one second initial body action driving subdata corresponding to the initial content text according to the time information; and
determining at least one initial body action driving data according to the at least one first initial body action driving data and the at least one second initial body action driving data.

7. The method according to claim 1, wherein the at least one initial material prompt text comprises an initial style material prompt text, and
the generating an initial video according to the at least one initial object action driving data and at least one initial material corresponding to at least one initial material prompt text comprises:
determining an initial object material according to an initial lighting material corresponding to the initial style material prompt text and the at least one initial object action driving data; and
generating the initial video according to the initial object material.

8. The method according to claim 7, wherein the at least one initial material prompt text further comprises an initial scene material prompt text, and
the generating the initial video according to the initial object material comprises:
obtaining a plurality of first initial video frames according to the initial object material, the initial lighting material and an initial scene material corresponding to the initial scene material prompt text; and
generating the initial video according to the plurality of first initial video frames.

9. The method according to claim 8, wherein the plurality of initial prompt texts further comprise an initial shot description prompt text, and
the obtaining a plurality of first initial video frames according to the initial object material, the initial lighting material and an initial scene material corresponding to the initial scene material prompt text comprises:
obtaining the plurality of first initial video frames according to the initial object material, the initial lighting material, the initial scene material and initial shot description information corresponding to the initial shot description prompt text.

10. The method according to claim 8, wherein the at least one initial material prompt text further comprises the initial style material prompt text, and
the generating the initial video according to the plurality of first initial video frames comprises:
determining initial video clipping information according to at least one of initial audio content data corresponding to the initial content text, an initial background sound effect material corresponding to the initial style material prompt text, an initial clipping style material corresponding to the initial style material prompt text or an initial transition style material corresponding to the initial style material prompt text;
obtaining at least one second initial video frame according to the initial video clipping information and the plurality of first initial video frames; and
generating the initial video according to the at least one second initial video frame.

11. The method according to claim 10, wherein the generating the initial video according to the at least one second initial video frame comprises:
packaging the at least one second initial video frame according to an initial video packaging material corresponding to the initial style material prompt text, so as to generate the initial video.

12. The method according to claim 1, wherein the determining a plurality of initial prompt texts according to an initial text input by a user comprises:
determining the plurality of initial prompt texts by using a large model according to the initial text and attribute information of the user,
wherein the large model is fine-tuned by using a plurality of sample texts and a plurality of preset prompt texts, and
the initial prompt text is determined from the plurality of preset prompt texts by using the large model.

13. The method according to claim 1, wherein the generating an initial video comprises:
presenting the initial video on a visual interface.

14. A method of processing a video, comprising:
determining at least one adjustment prompt text and at least one attribute adjustment information according to an adjustment text corresponding to a to-be-processed video, wherein the to-be-processed video corresponds to at least one to-be-adjusted material;
adjusting attribute information of the at least one to-be-adjusted material corresponding to the at least one adjustment prompt text according to the at least one attribute adjustment information corresponding to the at least one adjustment prompt text, so as to obtain at least one adjusted material; and
obtaining a processed video according to the at least one adjusted material.

15. The method according to claim 14, wherein the to-be-processed video is obtained according to an initial video, and the adjusting attribute information of the at least one to-be-adjusted material corresponding to the at least one adjustment prompt text comprises:
presenting, on a visual interface, an identification text of the to-be-adjusted material corresponding to the adjustment prompt text, in response to determining the to-be-adjusted material corresponding to the adjustment prompt text from the at least one to-be-adjusted material.

16. The method according to claim 14, wherein the obtaining a processed video according to the at least one adjusted material comprises:
presenting the processed video on a visual interface.

17. The method according to claim 14, wherein the determining at least one adjustment prompt text and at least one attribute adjustment information according to an adjustment text corresponding to a to-be-processed video comprises:
determining the at least one adjustment prompt text and at least one attribute adjustment information by using a large model according to the adjustment text.

18. An electronic device, comprising:
at least one processor; and
a memory communicatively connected to the at least one processor;
wherein the memory stores instructions executable by the at least one processor, and the instructions, when executed by the at least one processor, are configured to cause the at least one processor to at least:
determine a plurality of initial prompt texts according to an initial text input by a user, wherein the plurality of initial prompt texts comprise an initial content prompt text and an initial material prompt text;
determine a video content text and at least one initial object action driving data corresponding to the video content text according to the initial content prompt text; and
generate an initial video according to the at least one initial object action driving data and at least one initial material corresponding to at least one initial material prompt text.

19. An electronic device, comprising:
at least one processor; and
a memory communicatively connected to the at least one processor;
wherein the memory stores instructions executable by the at least one processor, and the instructions, when executed by the at least one processor, are configured to cause the at least one processor to implement the method according to claim 14.

20. A non-transitory computer-readable storage medium having computer instructions stored therein, wherein the computer instructions are configured to cause a computer to implement the method according to claim 1.
